(19) United States
(12) Patent Application Publication
(10) Pub. No.: US 2018/0177175 A1
(43) Pub. Date: Jun. 28, 2018

(54) VORTEX INSECT TRAP

(71) Applicant: INADAY'S BIOTECH CO., LTD., New Taipei City (TW)

(72) Inventor: Yi Yi TSAI, New Taipei City (TW)

(73) Assignee: INADAY'S BIOTECH CO., LTD., New Taipei City (TW)

(21) Appl. No.: 15/660,944

(22) Filed: Jul. 26, 2017

(30) Foreign Application Priority Data
Dec. 22, 2016 (TW) 105142698

(51) Int. Cl. A01M 1/06; A01M 1/14; A01M 1/22; A01M 1/20

(52) U.S. Cl. CPC A01M 1/06; A01M 1/20; A01M 1/223; A01M 1/145

(57) ABSTRACT

A vortex insect trap includes an insect trapping container, a fan and an insect-killing device. The insect trapping container internally defines an air flowing space, in which the insect-killing device is disposed. The air flowing space is enclosed in at least one flow-guiding wall surface and communicable with external environment via an air suck-in port and an air exit port of the vortex insect trap. The fan is mounted to the air exit port for sucking in external air via the air suck-in port and discharging air inside the air flowing space from the insect trapping container via the air exit port. When the fan operates, air sucked into the air flowing space flows along the flow-guiding wall surface to form a spiral air flow that flows toward a bottom of the air flowing space while carries insects sucked into the air flowing space to the insect-killing device.

### FIELD OF THE INVENTION

The present invention relates to an insect trap, and more particularly, to a vortex insect trap that produces a spiral air flow to suck in and kill insects, particularly mosquitoes.

### BACKGROUND OF THE INVENTION

A clean and comfortable living environment is one of the targets being pursued by people in the modern society. However, our existing living environment is actually filled with all kinds of pests, such as mosquitoes and flies, which endanger people's living environment and health. Flies like rotten foods and transfer hazardous substances in the rotten foods from one thing to another, forming a vector of diseases and causing many infectious diseases. On the other hand, mosquitoes like to consume human's blood and cause irritating rashes on the skin of people being stung by mosquitoes. In some worse conditions, people stung by a mosquito will suffer from some terrible infectious diseases, such as Dengue Fever, Malaria and the like. Therefore, these pests are a great threat to the safety of people's daily life.

To prevent mosquitoes and other insects from spreading viruses to human, there are various insect-killing products introduced into the market, such as flyflaps, flypapers, pesticides and mosquito coils. Mosquitoes and insects trapped and killed by the flyflaps and flypapers are exposed to the open air, which not only looks horrible but also has an adverse influence on the environmental sanitation. The flypapers will become less effective over time because dust and impurities in the air would also attach thereto. Therefore, it is necessary to frequently replace the used flypapers with new ones to ensure effective trapping and killing of hazardous insects and mosquitoes, which inevitable results in increased cost of insect killing. The pesticides and mosquito coils kill or repel mosquitoes and insects using some gases with particular smell. However, the gases produced by the pesticides and mosquito coils are also harmful to human health and will usually cause problems in environmental protection. Therefore, novel insect trapping devices less harmful to human health have been successively developed and introduced into the market.

Among others, light traps and insect traps are most widely used. The light trap takes advantage of the phototaxis of mosquitoes and insects and includes an electrified wire grid disposed around the lamp thereof. When mosquitoes and insects flying toward the light trap touch the electrified wire grid, they are electrocuted and killed. While the light trap provides pretty good mosquito-killing effect, it consumes a lot of power and has a potential safety risk. The insect trap is internally provided with luring baits and/or liquid capable of killing insects quickly. However, in practical use of the insect trap, the insect-killing liquid is easily spilled to cause environmental pollution that is difficult to clean up.

### SUMMARY OF THE INVENTION

A primary object of the present invention is to provide a vortex insect trap that includes a fan for producing a spiral air flow in the insect trap, so that insects lured and sucked into the insect trap are carried by the spiral air flow to an insect-killing device disposed in the insect trap and killed.

Another object of the present invention is to provide a vortex insect trap that ensures trapped insects are air-dried and killed without the chance of escaping from the insect trap.

A further object of the present invention is to provide a vortex insect trap that avoids accumulation of killed insects and dust on a fan of the insect trap, so that the fan can have a prolonged service life even when it has operated over a long period of time.

To achieve the above and other objects, the vortex insect trap according to an embodiment of the present invention includes an insect trapping container, a fan, an insect-killing device and a pipe. The insect trapping container includes a container body and a cap detachably assembled to the container body. The container body has an air suck-in port formed thereon, while an air exit port can be selectively formed on the container body or the cap, such that the air exit port and the air suck-in port are located at two different height positions. The container body with the cap assembled thereto internally defines an air flowing space, which communicates the air suck-in port with the air exit port.

The fan is mounted to the air exit port for sucking and discharging air inside the air flowing space from the insect trapping container via the air exit port, such that air outside the insect trapping container can be sucked into the air flowing space via the air suck-in port to flow along a flow-guiding wall surface surrounding the air flowing space and form a spiral air flow, which flows toward a bottom of the air flowing space and is finally discharged via the air exit port.

The insect-killing device is disposed in the air flowing space of the insect trapping container for ensnaring and confining insects to the air flowing space. The pipe includes an assembling opening for externally connecting to the air suck-in port and an adjustable opening that can be freely oriented in the x-axis, the y-axis or the z-axis direction, enabling the fan to suck in insects via the pipe from any position.

According to a preferred embodiment of the present invention, the air exit port is located at a height position higher than that of the air suck-in port; and the spiral air flow reaching at the bottom of the air flowing space naturally flows radially inward and turns into an ascending air flow that flows through a center of the spiral air flow toward the air exit port. The ascending air flow flowed to the air exit port is turned by the fan into a first outgoing air flow that flows in a direction perpendicular to the ascending air flow. In this embodiment, the air exit port is oriented in a direction non-perpendicular to the ascending air flow. In addition, the insect-killing device is an adhesive element capable of trapping or sticking insects thereto.

According to another preferred embodiment, the air exit port is selectively formed on a front, a rear, a left or a right side of the insect trapping container and is located at a height position lower than that of the air suck-in port, such that the spiral air flow flowed to the air exit port is turned into a second outgoing air flow that is tangent to the spiral air flow. In addition, the insect-killing device is an insect-killing solution or an electrified wire net.

In either of the above two preferred embodiments, the air flowing space can be a tapered space gradually narrowed from a top to a bottom of the insect trapping container or a right-prism space extended perpendicular to the top of the insect trapping container. Alternatively, the air flowing space can be enclosed in more than five adjoining flow-guiding wall surfaces and looks like a polygonal prism having more than five sides.

In an operable embodiment of the present invention, the pipe is formed of a plurality of pipe sections that can be telescoped into one another. A relative position between any two of the pipe sections is selectively changeable, such that the adjustable opening of the pipe can be moved closer to or farther away from the assembling opening.

The vortex insect trap of the present invention is characterized in that, when the fan rotates, air inside the air flowing space can be discharged from the insect trapping container while air outside the insect trapping container is sucked into the air flowing space, and that the air sucked into the air flowing space flows along the flow-guiding wall surface to form the spiral air flow, which flows toward the bottom of the air flowing space and carries the sucked-in insects to the insect-killing device, by which the insects are killed.

Moreover, the downward spiral air flow formed in the air flowing space not just confines the insects to the bottom of the air flowing space but also stops them from escaping out of the insect trapping container, so that the trapped insects are finally air-dried and killed by the spiral air flow in the vortex insect trap.

With the air exit port being located at a position higher than the air suck-in port and the fan being mounted to the air exit port, the air sucked into the air flowing space not only forms the downward spiral air flow but also further forms the ascending air flow, which flows through the center of the spiral air flow to the air exist port and is finally discharged from the insect trapping container. However, due to a centrifugal force of the spiral air flow, the insects and dust sucked into the air flowing space via the air suck-in port are confined to the bottom of the air flowing space without being carried by the ascending air flow to accumulate on the fan. Therefore, the fan of the vortex insect trap according to the present invention can have a prolonged service life.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a vortex insect trap according to a first preferred embodiment of the present invention;

FIG. 2 is an exploded view of the vortex insect trap of FIG. 1;

FIG. 3 shows a variant of the vortex insect trap of the first preferred embodiment having an insect trapping container internally defining a pentagonal air flowing space;

FIG. 4 is a sectional view showing the vortex insect trap of FIG. 1 in use;

FIG. 5 is an exploded perspective view of a vortex insect trap according to a second preferred embodiment of the present invention;

FIG. 6 is an assembled, partially sectioned side view of the vortex insect trap of FIG. 5;

FIG. 7 is a partially sectioned side view showing the vortex insect trap according to the second preferred embodiment of the present invention in use;

FIG. 8 is an assembled perspective view of a vortex insect trap according to a third preferred embodiment of the present invention;

FIG. 9 is a partially sectioned perspective view showing the vortex insect trap of FIG. 8 with a telescopic pipe thereof in a retracted state;

FIG. 10 is an exploded perspective view of a vortex insect trap according to a fourth preferred embodiment of the present invention; and

FIG. 11 is an assembled, partially sectioned side view showing the vortex insect trap of FIG. 10 in use.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

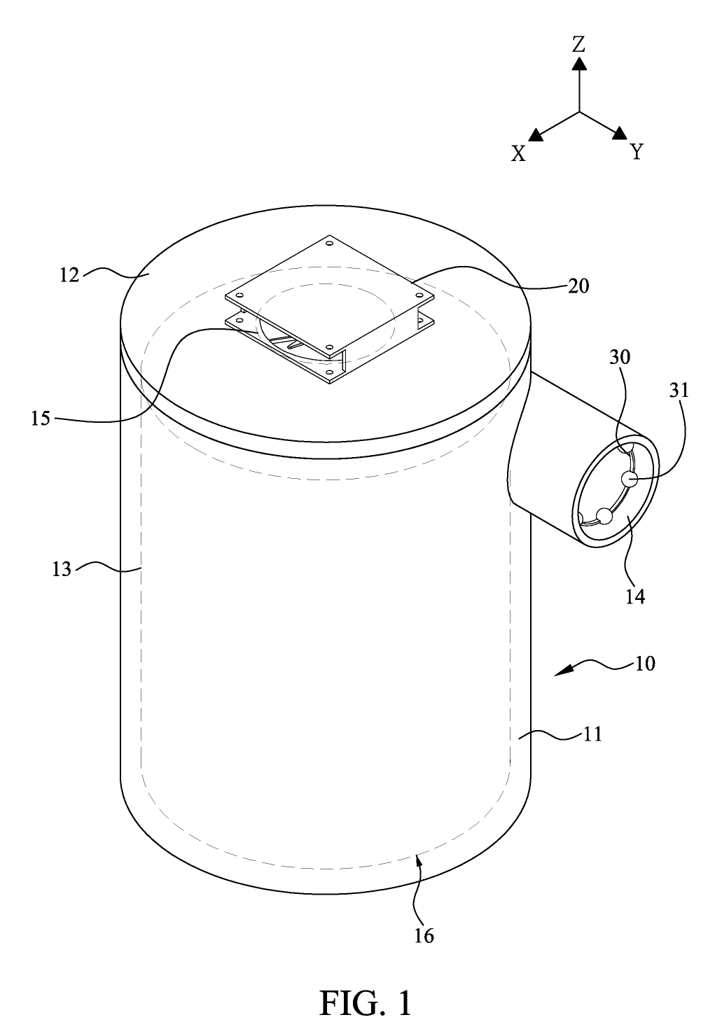

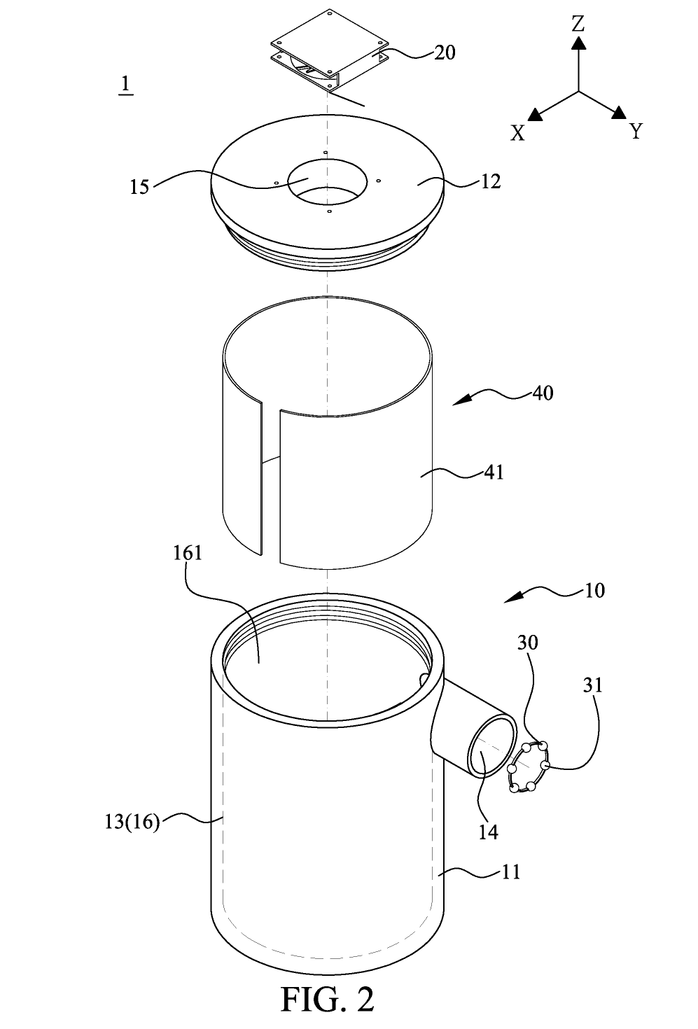

Please refer to FIGS. 1 and 2. A vortex insect trap 1 according to a first preferred embodiment of the present invention includes an insect trapping container 10, a fan 20, a luring device 30 and an insect-killing device 40. The insect trapping container 10 includes a container body 11 and a cap 12, which are detachably assembled to each other. The container body 11 internally defines a hollow space 13, which is sunken from a top toward a bottom of the container body 11 in a z-axis direction. An air suck-in port 14 extended in a y-axis direction is formed on one side of the container body 11 to communicate with the hollow space 13, and an air exit port 15 is formed on the cap 12 to extend through the cap 12 in a z-axis direction.

In the illustrated first preferred embodiment, the container body 11 and the cap 12 are assembled to each other via screw threads, such that the cap 12 covers and closes an open top of the hollow space 13 defined in the container body 11. At this point, the hollow space 13 in the insect trapping container 10 forms an air flowing space 16 communicable with the air suck-in port 14 and the air exit port 15, and the air suck-in port 14 is communicable with the air exit port 15 via the air flowing space 16. While the air suck-in port 14 and the air exit port 15 in the illustrated first preferred embodiment are oriented in the y-axis and the z-axis direction, respectively, it is understood the above description is only illustrative. That is, in other operable embodiments, the air suck-in port 14 can be otherwise oriented, for example, in the x-axis direction and the air exit port 15 can be otherwise oriented, for example, in a direction oblique to the z-axis.

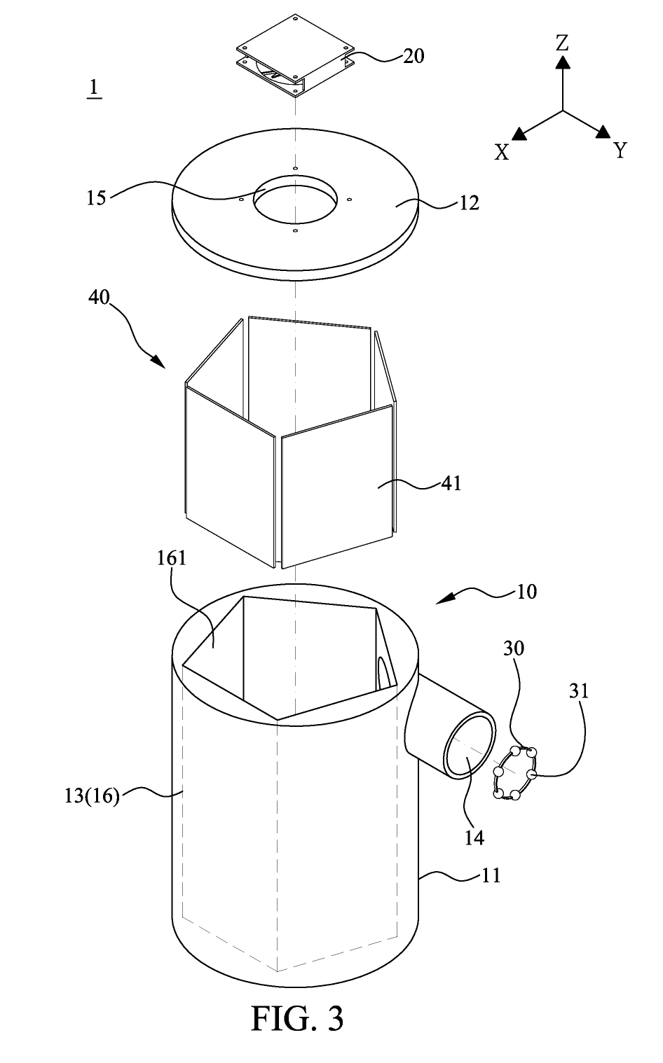

The air flowing space 16 is enclosed in an annular flow-guiding wall surface 161 or in an infinite number of adjoining flow-guiding wall surfaces 161 and accordingly, looks like a cylinder or an infinite-sided prism. However, it is understood the above description of the air flow space 16 is only illustrative and not intended to limit the present invention in any way. For example, as shown in FIG. 3, the air flowing space 16 can be enclosed in five adjoining flow-guiding wall surfaces 161 and accordingly, looks like a pentagonal prism. Similarly, in other operable embodiments, the air flowing space 16 can be enclosed in six, seven, eight or more flow-guiding wall surfaces 161 and looks like a hexagonal prism, a heptagonal prism, an octagonal prism or an infinite-sided prism. More specifically, the air flowing space 16 is configured as a right prism extended perpendicular to a top of the insect trapping container 10.

Please to FIGS. 1 and 2 again. The fan 20 is mounted to the air exit port 15 of the insect trapping container 10, the luring device 30 is mounted in the air suck-in port 14 of the insect trapping container 10, and the insect-killing device 40 is located in the air flowing space 16 of the insect trapping container 10. In the illustrated first preferred embodiment, the luring device 30 is a light-emitting element 31 for projecting a light source toward the air suck-in port 14, and the insect-killing device 40 is an adhesive element 41 attached to the flow-guiding wall surface 161 for ensnaring or trapping insects with a sticky substance while confining the insects to the air flowing space 16.

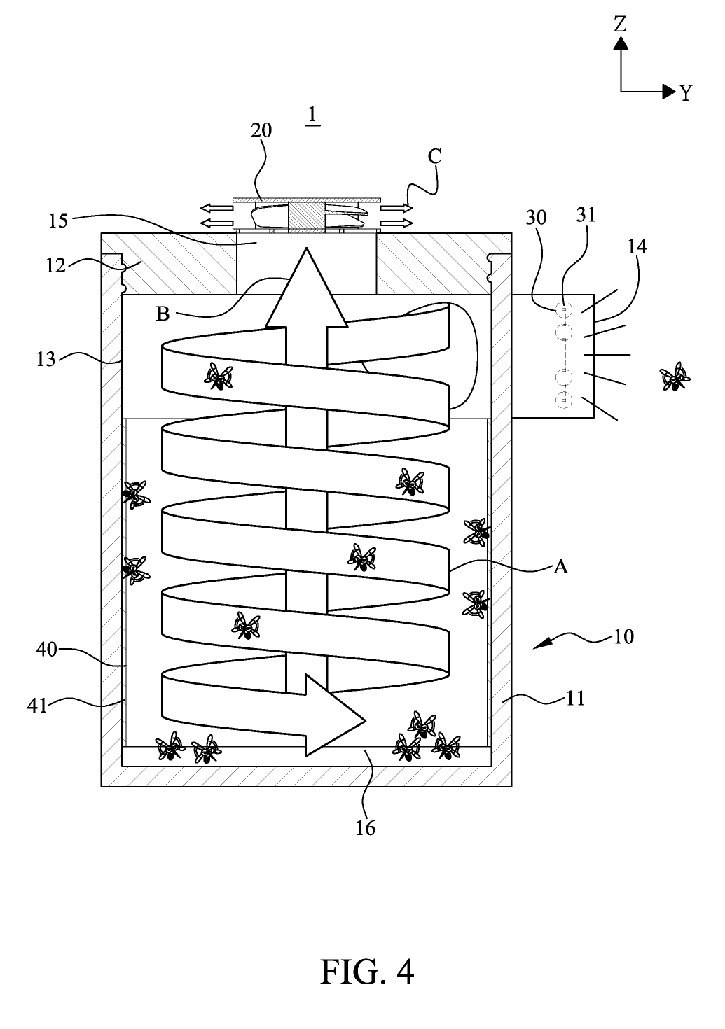

Please refer to FIG. 4. To use the vortex insect trap 1 according to the first preferred embodiment of the present invention, first connect the fan 20 to a power supply (not shown) and turn on the fan 20, so that air outside the air flowing space 16 is sucked into the air flowing space 16 via the air suck-in port 14. The external air sucked into the air flowing space 16 flows along the flow-guiding wall surface 161 to form a spiral air flow A, which flows down to a bottom of the air flowing space 16. The spiral air flow A reaching at the bottom of the air flowing space 16 naturally flows radially inward and turns into an ascending air flow B flowing through a center of the spiral air flow A, such that the spiral air flow A is revolving around the ascending air flow B while the ascending air flow B flows in the z-axis direction and brings air inside the air flowing space 16 toward the air exit port 15. Finally, the air inside the air flowing space 16 is discharged from the insect trapping container 10 via the air exit port 15. More specifically, the ascending air flow B flowed to the air exit port 15 will impact on the fan 20, which turns the ascending air flow B into a first outgoing air flow C that flows in a direction perpendicular to the ascending air flow B. As can be seen in FIG. 4, the air exit port 15 is oriented in a direction non-perpendicular to the ascending air flow B and the first outgoing air flow C is discharged from the insect trapping container 10 in a direction perpendicular to the z-axis. In the illustrated first preferred embodiment, the first outgoing air flow C flows in a direction nonparallel to the z-axis.

Meanwhile, turn on the light-emitting element 31 for the same to project a light source toward the air suck-in port 14 for attracting insects to the air suck-in port 14. Insects being attracted to the air suck-in port 14 are sucked into the air flowing space 16 and then brought by the spiral air flow A to the bottom of the air flowing space 16. On the way to the bottom of the air flowing space 16, insects touching the adhesive element 41 will be stuck to the adhesive element 41 and could not move. Other insects that are not caught by the adhesive element 41 will finally be air-dried and killed at the bottom of the air flowing space 16 by the spiral air flow A.

Due to a centrifugal force of the spiral air flow A, insects that are not stuck to the adhesive element 41 will be thrown to the bottom of the air flowing space 16 without being carried to the air exit port 15 by the ascending air flow B. Therefore, even when the fan 20 rotates for a long period of time, there won't be too many insects or dust accumulated on the fan 20, allowing the fan 20 to have a prolonged service life.

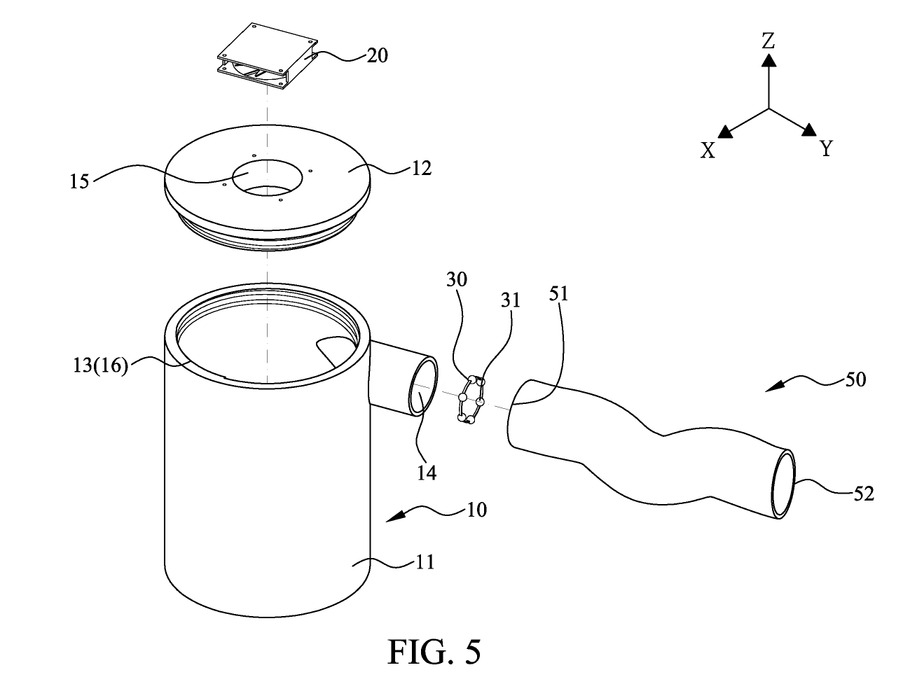

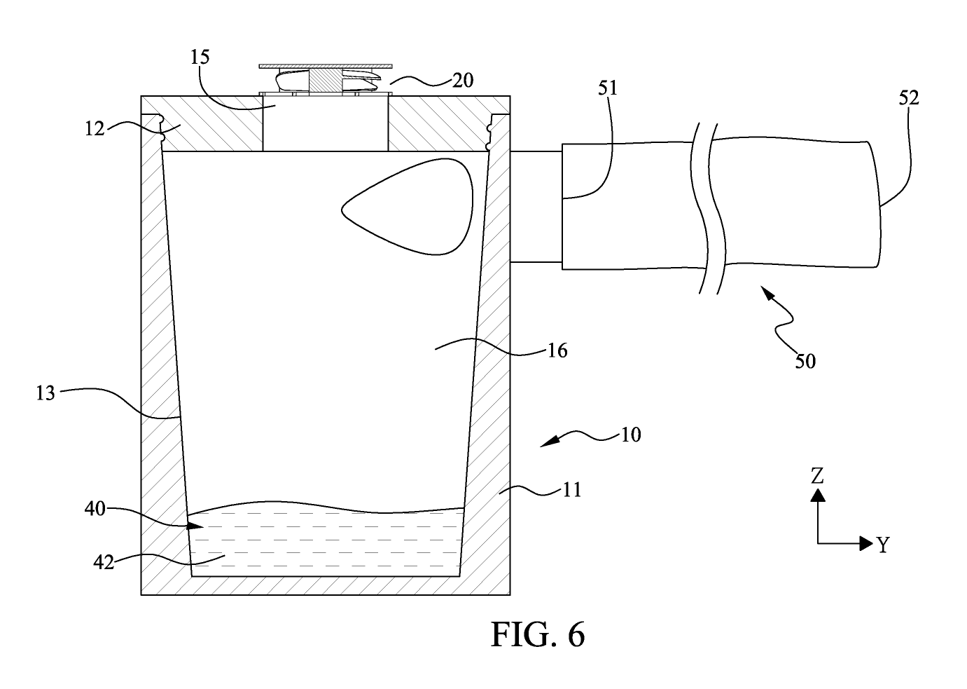

FIGS. 5 and 6 illustrate a vortex insect trap according to a second preferred embodiment of the present invention, which has an insect trapping container 10 and an insect-killing device 40 different from those in the first preferred embodiment and further includes a pipe 50. Since the fan 20 and the luring device 30 in the second preferred embodiment are the same as those in the first preferred embodiment, they are not repeatedly described herein. Only the insect trapping container 10, the insect-killing device 40 and the pipe 50 are described in detail herein.

As shown in FIGS. 5 and 6, in the second preferred embodiment, the insect trapping container 10 internally defines an air flowing space 16 that gradually narrows from top to bottom, and the insect-killing device 40 is an insect-killing solution 42, which can be a chemical agent or water. However, it is understood the insect-killing solution 42 is only illustrative and not intended to limit the present invention in any way. In other operable embodiments, the insect-killing device 40 can be, for example, an electrified wire net to provide the same function of killing trapped insects. As to the pipe 50, which has a partial section made of a flexible material and includes an assembling opening 51 for externally connecting to the air suck-in port 14 and an adjustable opening 52 that can be freely oriented in the x-axis, the y-axis or the z-axis direction.

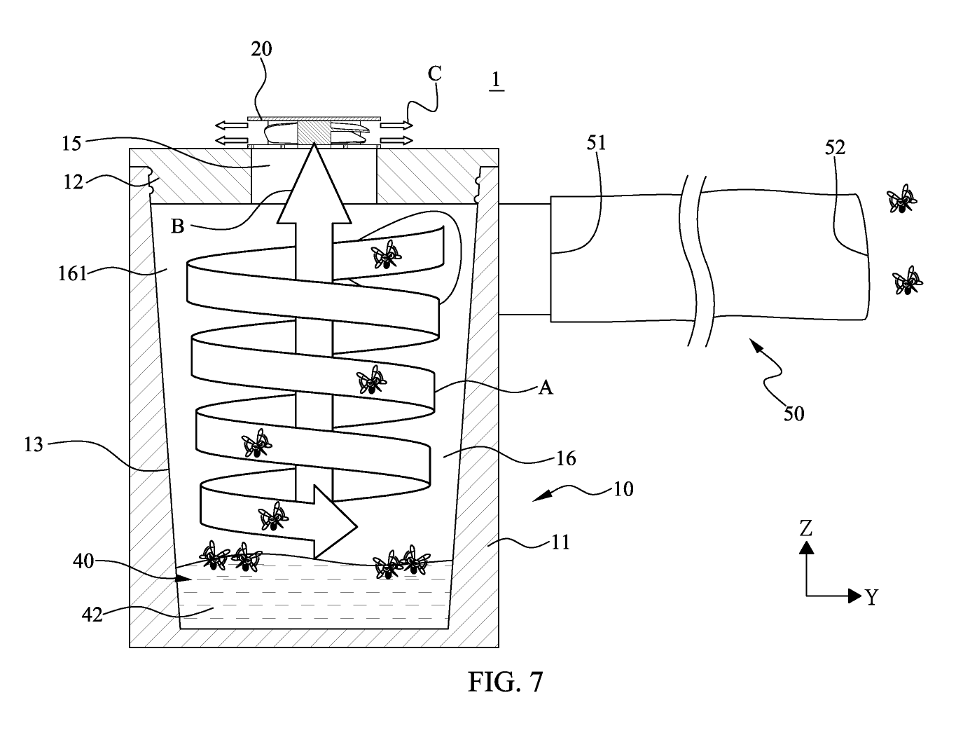

Please refer to FIG. 7. To use the vortex insect trap 1 according to the second preferred embodiment of the present invention, first turn on the fan 20 for it to rotate, so that air outside the insect trapping container 10 is sucked into the air flowing space 16 via the adjustable opening 52 of the pipe 50 to form the spiral air flow A. Since the air flowing space 16 is narrowed from top to bottom, the downward tapered configuration accelerates the flowing speed of the spiral air flow A in the air flowing space 16 and insects sucked into the air flowing space 16 are more quickly moved by the spiral air flow A to the bottom of the air flowing space 16, at where the insect-killing solution 42 is stored. Insects in contact with the solution 42 are killed. Since the pipe 50 has a partial section made of a flexible material, the adjustable opening 52 can be freely adjusted to orient in the direction of x-axis, y-axis or z-axis to approach different locations for the vortex insect trap to effectively suck in more insects.

In addition to the provision of the downward narrowed air flowing space 16, the provision of an air suck-in port 14 having a reduced opening size can also achieve the purpose of accelerating the flowing speed of the spiral air flow A.

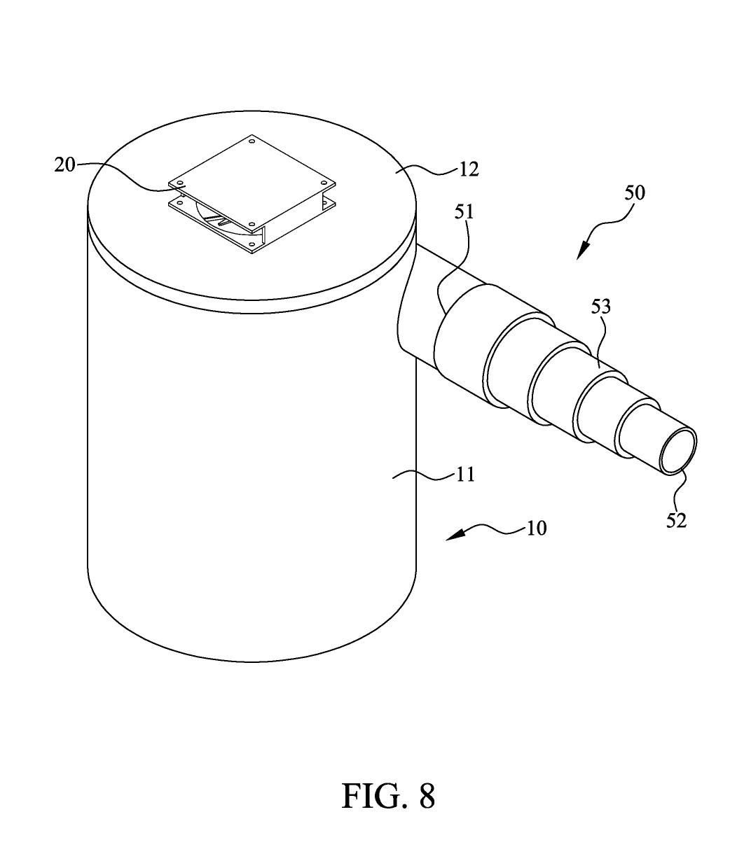

FIG. 8 illustrates a vortex insect trap according to a third preferred embodiment of the present invention, which is different from the second one in having a telescopic pipe 50 instead of the flexible pipe 50. Since the insect trapping container 10, the fan 20, the luring device 30 and the insect-killing device 40 in the third preferred embodiment are the same as those in the second preferred embodiment, they are not repeatedly described herein.

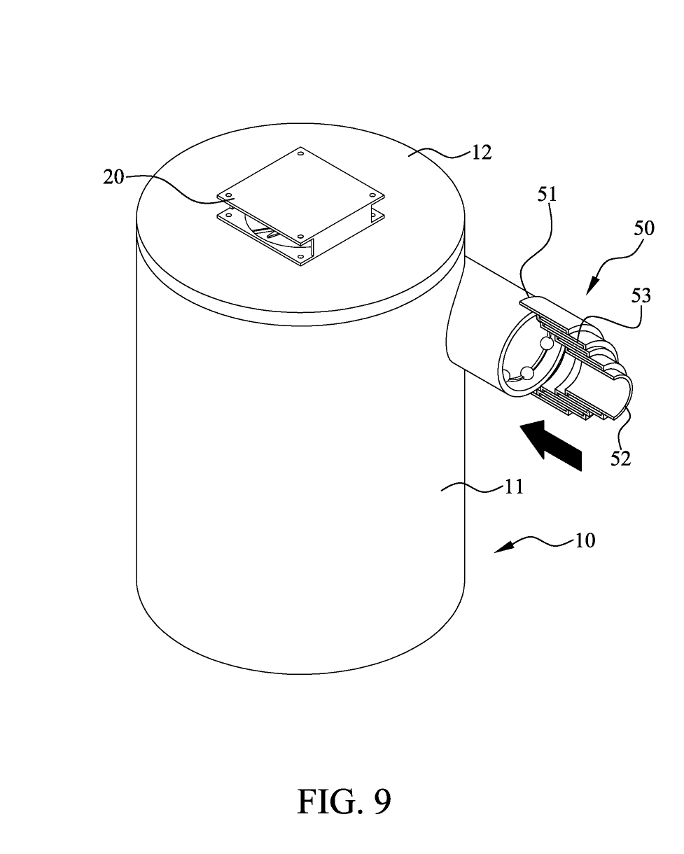

Please refer to FIGS. 8 and 9 at the same time. In the third preferred embodiment, the pipe 50 is formed of a plurality of pipe sections 53, which can be telescoped into one another. Each of the pipe sections 53 can be shifted relative to other pipe sections 53 to selectively change the relative position between any two pipe sections 53. Therefore, the adjustable opening 52 of the pipe 50 can be moved closer to or farther away from the assembling opening 51. When the adjustable opening 52 is located closer to the assembling opening 51, the pipe 50 has a reduced overall volume to facilitate convenient storage of the vortex insect trap 1 when the same is not in use.

It is noted a clearance is present between any two telescoped pipe sections 53. With these clearances, the adjustable opening 52 of the pipe 50 can be oriented in the x-axis, the y-axis or the z-axis direction.

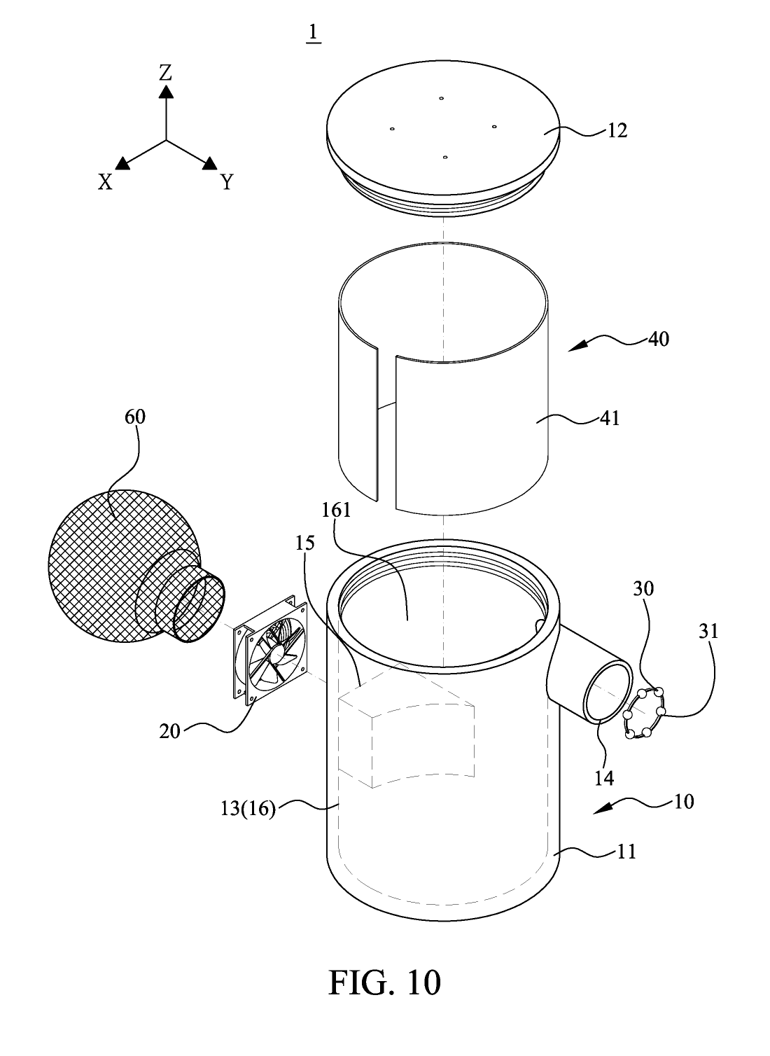

FIG. 10 illustrates a vortex insect trap 1 according to a fourth preferred embodiment of the present invention, which is different from the first one only in the insect trapping container 10. Since the fan 20, the luring device 30 and the insect-killing device 40 in the fourth preferred embodiment are the same as those in the first preferred embodiment, they are not repeatedly described herein.

As shown, in the fourth preferred embodiment, the insect trapping container 10 has an air exit port 15 formed on another side, which is the left side of the container body 11 when viewing in front of FIG. 10, of the container body 11 relative to the air suck-in port 14 at a height position lower than that of the air suck-in port 14. However, it is understood the forming of the air exit port 15 on the left side of the container body 11 is only illustrative. In other operable embodiments, the air exit port 15 can be otherwise formed on a front side, a rear side or a right side of the container body 11 when viewing in front of FIG. 10. Further, a mesh basket 60 is detachably connected to the air exit port 15.

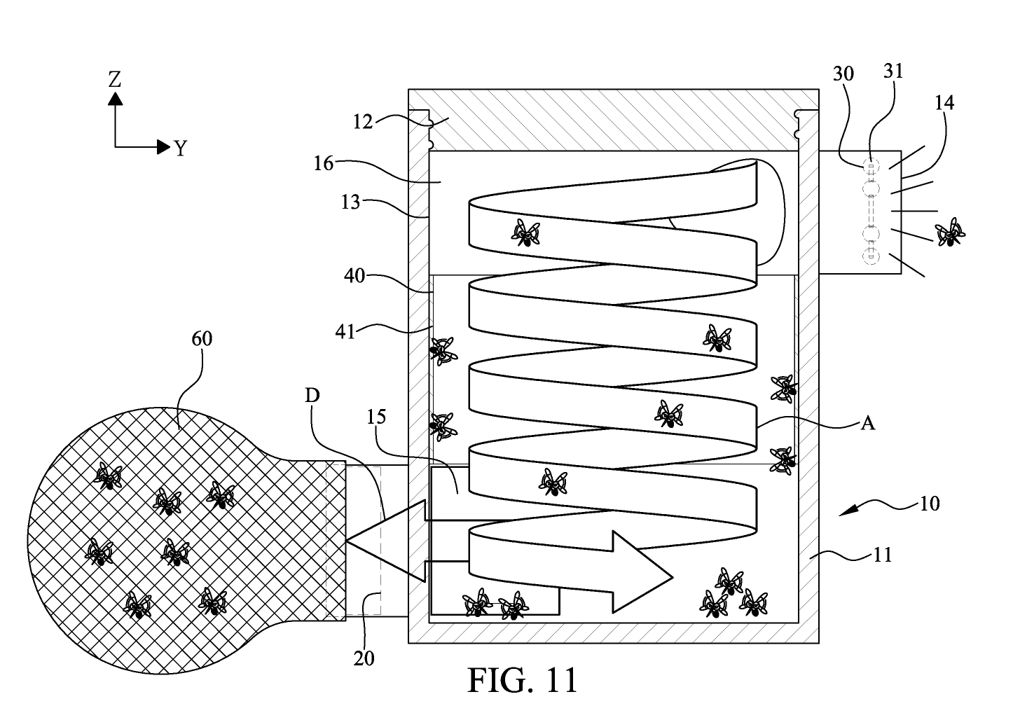

Referring to FIG. 11. To use the vortex insect trap 1 according to the fourth preferred embodiment of the present invention, first turn on the fan 20 for it to rotate, so that air outside the insect trapping container 10 is sucked into the air flowing space 16 via the air suck-in port 14 to form the spiral air flow A. The spiral air flow A flowing to the air exit port 15 is turned into a second outgoing air flow D, which is tangent to the spiral air flow A and flows in the y-axis direction. The trapped insects are carried by the second outgoing air flow D into the mesh basket 60 and finally killed when being air-dried by the continuous second outgoing air flow D.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A vortex insect trap, comprising:
an insect trapping container having an air suck-in port and an air exit port located at two different height positions; the insect trapping container internally defining an air flowing space that communicates the air suck-in port with the air exit port; and the air flowing space being enclosed in at least one flow-guiding wall surface;
a fan being mounted to the air exit port for sucking and discharging air inside the air flowing space from the insect trapping container via the air exit port, such that air outside the insect trapping container can be sucked into the air flowing space via the air suck-in port to flow along the flow-guiding wall surface and form a spiral air flow, which flows toward a bottom of the air flowing space and is finally discharged via the air exit port; and
an insect-killing device being disposed in the air flowing space of the insect trapping container for ensnaring and confining insects to the air flowing space.

2. The vortex insect trap as claimed in claim 1, wherein the air exit port is located at a height position higher than that of the air suck-in port; and wherein the spiral air flow reaching at the bottom of the air flowing space naturally flows radially inward and turns into an ascending air flow that flows through a center of the spiral air flow toward the air exit port.

3. The vortex insect trap as claimed in claim 2, wherein the air exit port is oriented in a direction non-perpendicular to the ascending air flow.

4. The vortex insect trap as claimed in claim 2, wherein the ascending air flow flowed to the air exit port is turned by the fan into a first outgoing air flow that flows in a direction perpendicular to the ascending air flow.

5. The vortex insect trap as claimed in claim 1, wherein the air exit port is selectively formed on a front, a rear, a left or a right side of the insect trapping container and is located at a height position lower than that of the air suck-in port, such that the spiral air flow flowed to the air exit port is turned into a second outgoing air flow that is tangent to the spiral air flow.

6. The vortex insect trap as claimed in claim 1, wherein the air flowing space is enclosed in more than five adjoining flow-guiding wall surfaces, such that the air flowing space looks like a polygonal prism having more than five sides.

7. The vortex insect trap as claimed in claim 1, wherein the air flowing space has a shape selected from the group consisting of a tapered configuration gradually narrowed from a top to a bottom of the insect trapping container and a right-prism configuration extended perpendicular to the top of the insect trapping container.

8. The vortex insect trap as claimed in claim 1, wherein the insect trapping container includes a container body, on which the air suck-in port is formed, and a cap detachably assembled to the container body.

9. The vortex insect trap as claimed in claim 1, further comprising a pipe; and the pipe including an assembling opening for externally connecting to the air suck-in port and an adjustable opening that can be freely oriented in the x-axis, the y-axis or the z-axis direction, enabling the fan to suck in insects via the pipe from any position.

10. The vortex insect trap as claimed in claim 9, wherein the pipe is formed of a plurality of pipe sections that can be telescoped into one another; and a relative position between any two of the pipe sections being selectively changeable, such that the adjustable opening of the pipe can be moved closer to or farther away from the assembling opening.

11. The vortex insect trap as claimed in claim 1, wherein the insect-killing device is selected from the group consisting of an adhesive element capable of trapping or sticking insects thereto, a solution that kills insect immediately, and an electrified wire net.
